(19) United States
(12) Patent Application Publication
(10) Pub. No.: US 2025/0136476 A1
(43) Pub. Date: May 1, 2025

(54) A FOG (FATS, OILS, OR GREASE) SEPARATION APPARATUS

(71) Applicant: ECO CLARITY LTD., London (GB)

(72) Inventor: Christopher Charles CLEMES, London (GB)

(21) Appl. No.: 18/730,518

(22) PCT Filed: Jan. 18, 2023
(86) PCT No.: PCT/IB2023/050416

§ 371 Date: Jul. 19, 2024

(30) Foreign Application Priority Data
Jan. 24, 2022 (ZA) 2022/01032

(51) Int. Cl. C02F 1/40; C02F 1/00; C02F 1/24

(52) U.S. Cl. CPC C02F 1/40; C02F 1/008; C02F 1/24; C02F 2001/007; C02F 2209/40; C02F 2209/42

(57) ABSTRACT

A FOG (Fats, Oils, or Grease) separation apparatus includes a vessel defining a cavity to contain liquid comprising wastewater and FOG, the vessel having an upwardly inwardly inclined side or top wall so that the cavity tapers inwardly towards a top section. A floating weir is operable to float on the liquid within the vessel and configured to collect or separate lighter FOG from heavier wastewater. A liquid level control mechanism is configured to control a liquid level within the vessel, such that (1) when the liquid level is higher, a surface area of the liquid will be smaller due to the inwardly tapering cavity and the FOG will be concentrated in the smaller surface area and (2) when the liquid level is lower, the surface area of the liquid will be larger, and the FOG will be distributed in the larger surfaces area.

### FIELD OF INVENTION

This invention relates generally to wastewater treatment and specifically to separation of FOG (Fats, Oils, or Grease) from wastewater.

### BACKGROUND OF INVENTION

The Applicant is active in the wastewater treatment field. It has experienced technical challenges in creating wastewater treatment plants which are adjustable, automatable, and/or cyclical.

The Applicant has filed PCT application no. PCT/IB2020/050334 relating to wastewater treatment, for a floating collector or floating weir. The Applicant has found that the floating weir principle is useful and wishes to develop this further.

Accordingly, the applicant desires an apparatus incorporating a floating weir which can be used for collection of FOG and which has a degree of control in how the FOG can be collected.

### SUMMARY OF INVENTION

Accordingly, the invention provides a FOG separation apparatus which includes:
a vessel or reservoir defining therein a cavity to contain liquid comprising wastewater and FOG, the vessel having an upwardly inwardly inclined side or top wall so that the cavity tapers inwardly towards a top section thereof;
a floating weir operable to float at a surface of the liquid within the vessel, the floating weir being configured to collect or separate lighter FOG from heavier wastewater; and
a liquid level control mechanism configured to control a liquid level of the liquid within the vessel, such that:
   when the liquid level is higher within the top section, a surface area of the liquid will be smaller due to the inwardly tapering cavity and the FOG will be concentrated in the smaller surface area; and
   when the liquid level is lower within the top section or is beneath the top section, the surface area of the liquid will be larger, and the FOG will be distributed in the larger surface area.

The terms “higher” and “lower” may be relative to each other or relative to a reference point. This may also be interpreted as “a first liquid level” which is higher than “a second liquid level”.

Accordingly, it may be noted that varying the liquid level within the reservoir can vary the depth and/or concentration of FOG at the surface. FOG, being more buoyant than water or wastewater, tends to stratify at the surface. Accordingly, if there was a given depth of FOG, say 1 cm, when the liquid level is beneath the top section, then raising the liquid level towards the top section so that the effective surface area decreases, say by half, then the depth of FOG will increase, say to 2 cm (1 cm/0.5).

The FOG separation apparatus may include one or more fluid inlets or outlets. The FOG separation apparatus may include one or more of: a main inlet (for liquid), a main outlet (for wastewater), a weir inlet (for flushing or recirculated liquid), and/or a weir outlet (for FOG collected by the floating weir). The liquid level control mechanism may be configured to control the liquid level by controlling the net inflow or outflow of liquid through the inlets or outlets. One or more of the inlets and/or outlets may have valves or taps associated therewith, which may be controlled thereby to control the inflow or outflow.

The liquid level control mechanism may therefore include one or more valves. The valves could be manually controlled (e.g., by a human supervisor). However, the Applicant envisages that the valves and the liquid level may be electronically or digitally controlled by at least one control module. In such case, the liquid level control mechanism may include the electronic control module.

The FOG separation apparatus may include one or more sensers, e.g., liquid level sensors, FOG density sensors, flow sensors, etc. The electronic control module may be configured to control the liquid level in accordance with one or more readings from the sensors. The electronic control module may be configured to control the liquid level in accordance with one or more predefined operational parameters.

A bottom of the vessel may include a tapered (e.g., inverted conical) sump. The sump may therefore converge inwardly downwardly. A drain outlet may be provided at a low point of the sump to drain to collect denser or sinking material, e.g., solids (whether dissolved or suspended), grit, etc.

The floating weir may be as disclosed in PCT/IB2020/050334, may have some, but not all, of the features of this disclosure, or may be different.

The FOG separation apparatus may include a bubbler provided in the cavity to supply bubbles or nanobubbles.

The FOG separation apparatus may include a pre-filter. The pre-filter may be, or may include, a press system or a screening system. The press system may include a screw press to remove larger solids. The screening system may include one or more layers of mesh to screen out larger solids.

The vessel may be insulated.

The FOG separation apparatus may include two similar or identical vessels in series, which may be fluidically interconnected, each with its own floating weir. This may be useful when FOG is supplied to the (first) vessel in an agitated or emulsified state, and not all of the FOG floats to the surface. The series (second) vessel, with its floating weir, may be configured to remove FOG not removed in the first vessel which, by the time the wastewater is provided to the series vessel, has floated to the top.

The vessel may be a first vessel and the FOG separation apparatus may include a dissimilar second vessel provided in-line with and downstream of the first vessel. The first vessel may be intended primarily or entirely to remove FOG, while the second vessel may not.

The second vessel may also define therein a cavity (namely, a second cavity) to contain liquid comprising wastewater and the second vessel may also have an upwardly inwardly inclined side or top wall so that the cavity tapers inwardly towards a top section thereof. The second vessel may also include a floating weir (namely, a second floating weir) operable to float at a surface of the liquid within the second vessel. Alternatively, the second vessel may only include fixed outlets, e.g., weirs, ports, or drains.

In one embodiment, the second vessel may be configured primarily for FOG removal (like the first vessel). Thus, the FOG separation apparatus may include two stages (provided respectively by the first and second vessels) of FOG removal. However, in another embodiment, the second vessel may be configured primarily for a different purpose.

The FOG separation apparatus may include a bubbler provided in the second cavity of the second vessel to supply bubbles or nanobubbles. The bubbles may serve one or more functions like liquid agitation, acting as a flocculant to bind to suspended particles (e.g., suspended solids), etc.

The bubbles may cause a foam or slurry to form, which may be buoyant relative to the remainder of the wastewater. The second weir may be configured to collect or harvest this foam or slurry. The second vessel may thus be configured to remove suspended solids or particles.

The bubbles may influence an oxygen level of the liquid. Accordingly, the bubbles may influence Chemical Oxygen Demand (COD) based reactions which may occur in the second vessel.

The bubbler may be configured to provide bubbles of, or including, oxygen (O₂), ozone (O3), or the like. The bubbles may have a beneficial effect on a water chemistry of the liquid in the second vessel, e.g., serving to neutralise some chemicals or to inhibit growth of certain bacteria.

The FOG separation apparatus may include a charge generator to charge (e.g., negatively charge) the bubbles supplied by the bubbler.

The second weir may be tethered to the second vessel by a tether. The tether may be weighted to draw or urge the second weir back to a reference point, e.g., to one side of the liquid surface.

A bottom of the second vessel may include a tapered (e.g., inverted conical) sump. The sump may therefore converge inwardly downwardly. A drain outlet may be provided at a low point of the sump to drain to collect denser or sinking material, e.g., solids (whether dissolved or suspended), grit, etc.

The first and second vessels may be provided by separate structures or containers and may be interconnected by one or more tubes or conduits. The first and second vessels may be provided by the same structure or container and may be separated by a wall, weir, or baffle.

There may be more than two vessels in series, e.g., first and second similar vessels with floating weirs, and a third dissimilar vessel without a floating weir, and other combinations may be practicable.

The invention extends to a method of operating a FOG separation apparatus as defined above, the method including:
varying the liquid level within the top section to vary the surface area of the liquid, and hence of the FOG at the top of the liquid; and
collecting the FOG with the floating weir.

### BRIEF DESCRIPTION OF DRAWINGS

The invention will now be further described, by way of example, with reference to the accompanying diagrammatic drawings.

In the drawings:

FIG. 1 shows a schematic side view of a first embodiment of a FOG separation apparatus in accordance with the invention;

FIG. 2 shows a schematic side view of the FOG separation apparatus of FIG. 1 with a higher liquid level;

FIG. 3 shows a schematic side view of a second embodiment of a FOG separation apparatus in accordance with the invention;

FIG. 4 shows a schematic side view of a third embodiment of a FOG separation apparatus in accordance with the invention;

FIG. 5 shows a schematic side view of a fourth embodiment of a FOG separation apparatus in accordance with the invention;

FIG. 6 shows a schematic side view of the FOG separation apparatus of FIG. 5 with a higher liquid level;

FIG. 7 shows a schematic side view of a second vessel of a fifth embodiment of a FOG separation apparatus in accordance with the invention; and

FIG. 8 shows a schematic side view of a sixth embodiment of a FOG separation apparatus in accordance with the invention.

### DETAILED DESCRIPTION OF EXAMPLE EMBODIMENT

The following description of an example embodiment of the invention is provided as an enabling teaching of the invention. Those skilled in the relevant art will recognise that changes can be made to the example embodiment described, while still attaining the beneficial results of the present invention. It will also be apparent that some of the desired benefits of the present invention can be attained by selecting some of the features of the example embodiment without utilising other features. Accordingly, those skilled in the art will recognise that modifications and adaptations to the example embodiment are possible and can even be desirable in certain circumstances and are a part of the present invention. Thus, the following description of the example embodiment is provided as illustrative of the principles of the present invention and not a limitation thereof.

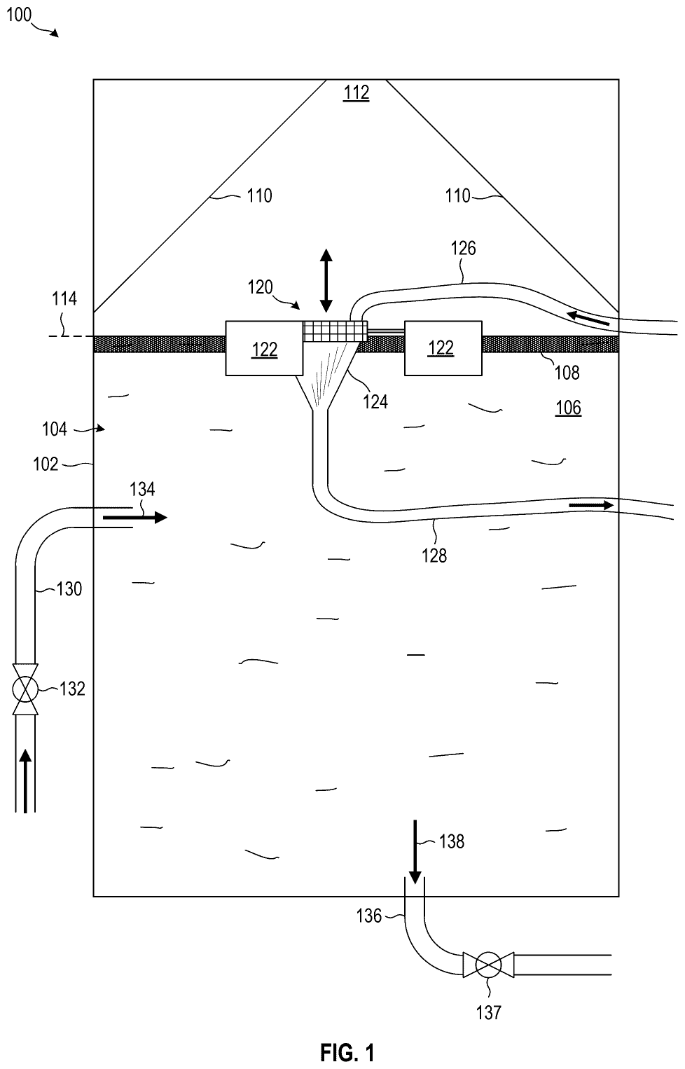

FIG. 1 illustrates a FOG separation apparatus 100 which includes a vessel 102 defining therein a cavity 104. While the vessel 102 need not necessarily have any predefined outward appearance or shape, it may conveniently be rectangular or cylindrical.

The cavity 104 of the vessel 102 is for accommodating liquid which comprises wastewater 106 and FOG 108. There is not always a clear distinction or separation between the wastewater 106 and the FOG 108, but characteristically the FOG 108 is less dense and therefore more buoyant, and rises to the surface in a stratified layer, as illustrated with the FOG 108 shaded. There may well, however, still be particles of FOG present in the wastewater 106 and particles of wastewater in the FOG 108.

Further, some solids or solid particles may be present at all levels (e.g., sinking solids, suspended solids, and/or floating solids).

Importantly, the vessel 102 has an inclined wall 110—or pair of inclined walls 110 in this case. The inclination of the walls is upwardly inwardly so that the cavity 104 tapers inwardly towards a top section 112 thereof. Accordingly, a surface area of the cavity 104 decreases towards the top section 112.

The FOG separation apparatus 100 has a floating weir 120 which is configured to float at a surface 114 of the liquid, typically at a surface of—or in—the FOG 108. The floating weir 120 includes a plurality of buoyant or floating members 122 and a collector funnel 124 having a top lip with an upwardly open mouth which acts as a weir. The floating weir 120 may be as described in PCT/IB2020/050334 or may have some of the features of that disclosure. In this example, the floating weir 120 is similar to the FOG collector described in PCT/IB2020/050334 but lacks the heaters (although these may be included, if desired).

The floating weir 120 has a weir inlet 126 and a weir outlet 128. The weir inlet 126 may be optional and is configured for receiving warm flushing liquid or wastewater. The flushing water may be intended (1) to clean the collector funnel 124 from any debris or accumulated FOG or solids and/or (2) to warm—or to assist in warming—the surrounding wastewater 106 and FOG 108 to a desired operating temperature (e.g., 40°-60° Celsius). The weir outlet 128 is to direct funnelled FOG (usually quite concentrated FOG) collected by the floating weir 120 to onward storage or processing.

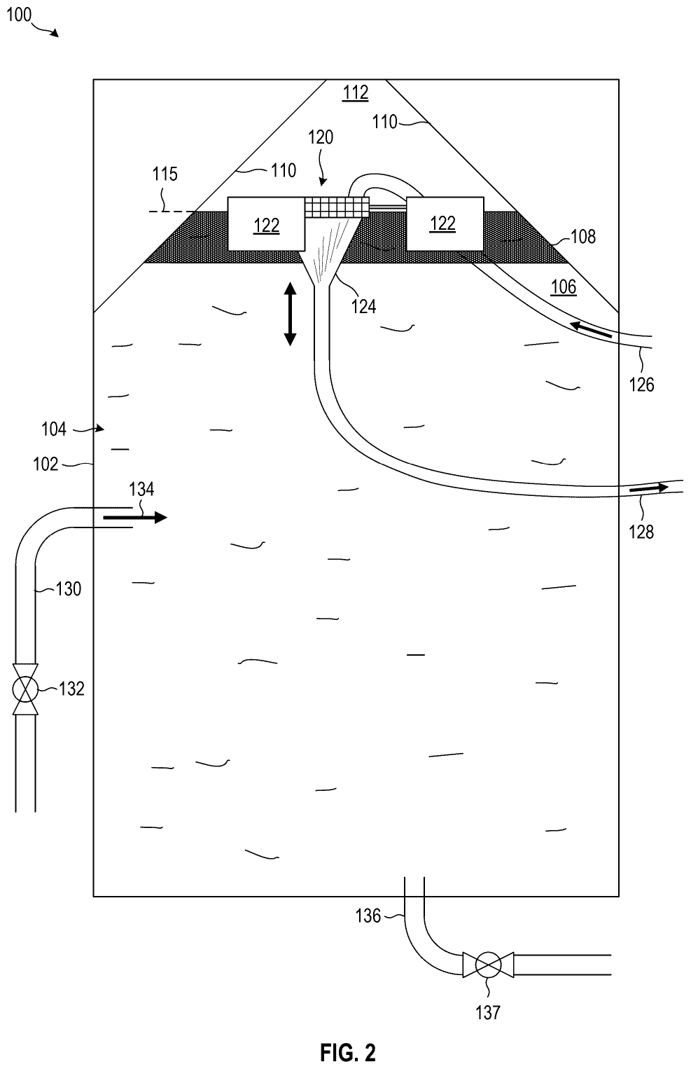

The apparatus 100 has a main inlet 130 and a main outlet 136 into and out of the vessel 102. The main inlet 130 may be configured to deliver influent or FOG-containing wastewater/liquid 134. The main inlet 130 may deliver the influent 134 warmed to a desired operating temperature of 40°-60°. At this temperature, the influent 134 may separate or stratify into the wastewater 106 and FOG 108 illustrated in FIGS. 1-2. The main inlet 130 has an inlet valve 132 configured to control an amount of the influent 134 delivered into the vessel 102.

Further, in addition to delivering fresh influent 134 to be separated, the main inlet 130 and valve 134 may be controlled to raise the liquid level 114. Where the liquid level 114 needs to be raised but no more FOG-containing influent is available, then recycled (and optionally warmed) wastewater may be delivered via the main inlet 130. The main inlet 130 and coupled inlet valve 132 thus act as a liquid level control mechanism (or a part thereof).

Similarly, the main outlet 136 has an outlet valve 137 and is configured for removing wastewater 106 (indicated by arrow 138) from the vessel 102. Usually, the main outlet 136 is towards a bottom of the vessel 102 and thus removes denser, FOG-sparce wastewater 106 and possibly also settled/sinking or suspended solids. The outlet valve 137 can be operated to control (specifically, decrease) the liquid level 114 in the vessel 102. Accordingly, the main outlet 136 and coupled outlet valve 137 also act as part of the liquid level control mechanism.

Although not illustrated, the apparatus 100 may include sensors configured to sense the liquid level 114 and a control module coupled to the sensors and configured to actuate the inlet and outlet valves 132, 137. This may enable automated control of the liquid level. Further, the sensors may be configured to sense a FOG concentration (e.g., by means of a capacitive sensor), and the control module may be configured to adjust the liquid level based, at least in part, on the sensed FOG concentration.

FIG. 1 illustrates the apparatus 100 with the liquid level 114 at a lower level below the pair of inclined walls 110. Turning to FIG. 2, a liquid level 115 has been raised so that the liquid level 115 is at, or in line with, a part of the pair of inclined walls 110. The liquid level 115 could have been increased by introducing additional influent 134 via the main inlet 130 and/or by introducing additional recycled wastewater via the weir inlet 126. The liquid level 115 has accordingly risen so that it is closer to the top section 112 and between the inclined walls 110.

As per FIG. 2, the liquid level 115 has increased and moved higher relative to the tapered walls 110, and an effective surface area of the liquid has decreased. Accordingly, the layer of the FOG 108 is thicker; accommodating the same amount in a thinner width dimension will cause an increase in a height dimension. This increase in the thickness (or depth) of the FOG 108 may make collecting it via the floating weir 120 easier or more efficient. As the floating weir 120 is floating, it will automatically float or adjust to the new liquid level 115.

Lowering the liquid level 114, and accordingly the floating weir 120, can be achieved by removing liquid from the vessel 102, via the main outlet 136 and/or the weir outlet 128. Accordingly, the weir inlets and outlets 126, 128 can also be considered to be part of the liquid level control mechanism. The difference between FIG. 1 and FIG. 2 illustrates an important aspect of the present invention: by adjusting the liquid level 114, 115, the layer of FOG 108 can be moved up or down relative to the inclined side walls 110, which varies a height or thickness of the FOG 108. As the floating weir 120 is buoyant, it self-adjusts to the liquid level 114, 115 and can collect the FOG 108 from the surface.

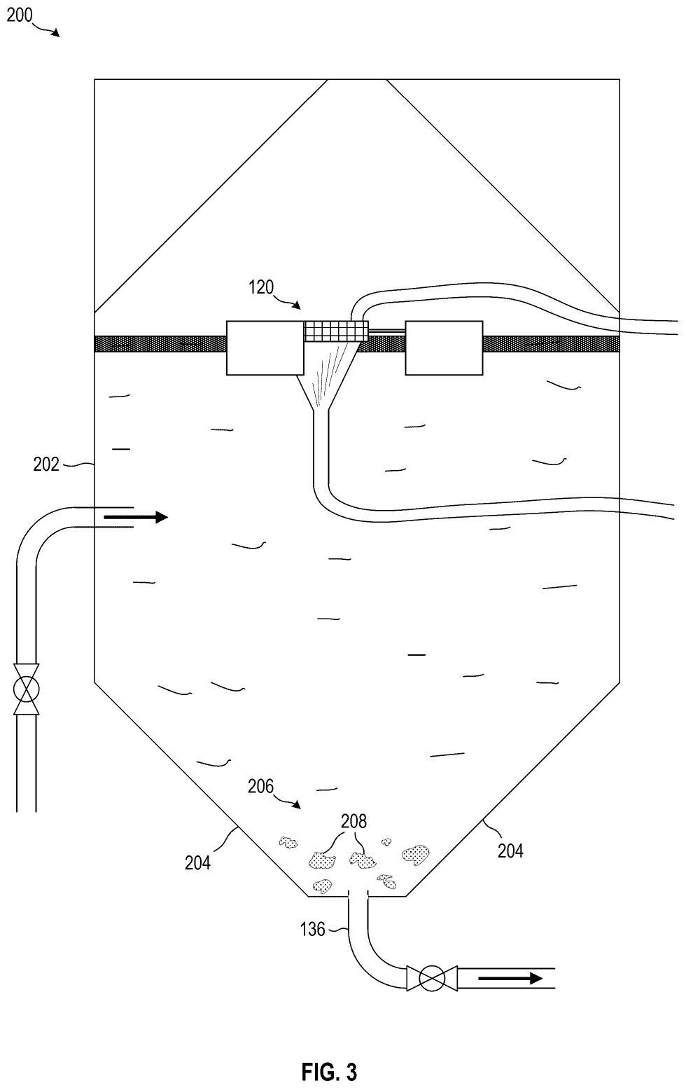

FIG. 3 illustrates another embodiment of a FOG separation apparatus 200 with a vessel 202 which includes many of the features of the FOG separation apparatus 100 of FIGS. 1-2. Notably, the vessel 202 also has inclined sides 204 at its bottom to provide a tapered sump 206. Denser or sinking solids 208 will collect and settle in the tapered sump 206 and the main outlet 136 is now provided at a bottom of the tapered sump 206 to release, suck, or syphon out the settled solids 208.

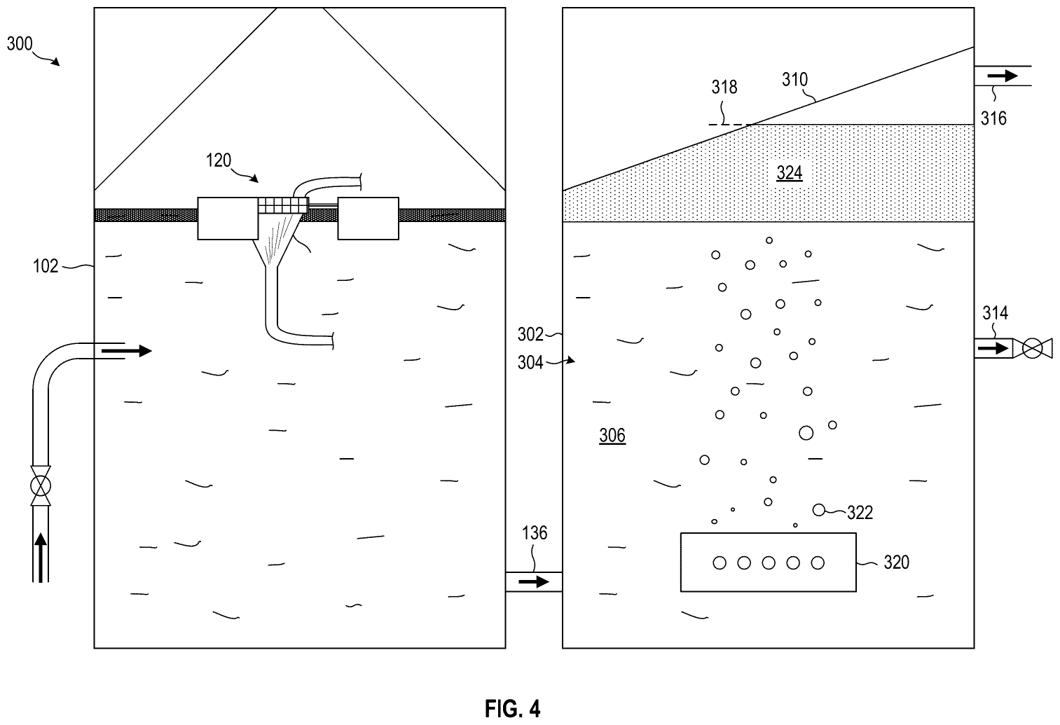

FIG. 4 illustrates a further embodiment of a FOG separation apparatus 300 comprising two vessels 102, 302. A first vessel 102 is as disclosed in FIGS. 1-2 wherein the main outlet 136 of the first vessel is connected to, and serves as a main inlet of, a second vessel 302 which defines a cavity 304 (a second cavity) therein.

The second vessel 302 could have been configured similarly to the first vessel 102 for a second level of FOG separation. However, in this example, it is configured differently. The second vessel 302 defines therein the second cavity 304 for accommodating wastewater 306 from which FOG 108 has largely been removed by the first vessel 102. However, various solids, e.g., floating, suspended, or settled solids, may still be present in the wastewater 306, even if the first vessel 102 of FIG. 3 removed some settled solids 208.

The second vessel 302 also has an inclined side or top wall 310 slanting from one sidewall of the vessel 302 across to the other sidewall (in a slightly different configuration from that of the first vessel 102). If the two vessels 102, 302 have a hydraulically common and open link, the respective liquid levels 114, 318 may be the same; however, if a valve or similar mechanism is provided in the main outlet 136, the vessels 102, 302 may be hydraulically separated and may have independent levels 114, 138.

The second vessel 302 does not include a floating weir but rather has two outlets 314, 316. A second main outlet 314 is provided roughly in a middle, or towards a bottom, of the second vessel 302. The second main outlet 314 can be used to remove general wastewater 306 from the second vessel 302 and to control a second liquid level 318 (at least by allowing it to be lowered). A weir or skimmer outlet 316 is provided higher up on the vessel 302 and above or inline with the inclined wall 310.

The apparatus 300 has a bubbler 320 provided in the second cavity 304 of the second vessel 302. The bubbler 320 is configured to release bubbles 322 into the wastewater 306 in the cavity 304. The bubbler 320 may make the bubbles 322, by means of a chemical/electrochemical reaction, or may merely release them, e.g., by being an outlet. The bubbles 322 may be air, oxygen, ozone, charged, normal sized, nano sized, etc.

Regardless of the specific composition of the bubbles 322, they are intended to perform at least the function of acting as a flocculant or binder for suspended/dissolved solids in the wastewater 306. The bubbles 322 bind with or to the suspended solids, causing them to become more buoyant and form a slurry, foam, or froth 324 (in similar fashion to a protein skimmer used in water filtration). As the slurry 324 comprises the bubbles, it is lighter or more buoyant than the wastewater 306 and thus rises to the surface.

As the slurry 324 rises, the inclined wall 310 channels and concentrates it towards the weir outlet 316 until it overflows through the weir outlet 316 and onward for storage, collection, or processing. In similar fashion to the first vessel 102, the liquid level 318 (including the slurry 324) can be controlled up or down by either filling the second vessel 302 via the first main outlet 136 or emptying it via the second main outlet 314, both of which may be manual or automated processes.

A variation on the two-vessel apparatus 300 of FIG. 4 may be to have two identical vessels, e.g., two vessels 202 of FIG. 3, connected in series (not illustrated). They may be fluidically interconnected by the main outlet 136 of the first vessel 202 and the main inlet 130 of the second vessel 202. In addition, or instead, the weir inlets 126 and weir outlets 128 of one or both vessels 202 may be connected to the weir inlet 126 or weir outlet 128 of the other vessel and/or to the main inlet 130 or outlet 136 of the other vessel. The floating weirs 120 of the respective vessels 202 may be operated independently or even oppositely such that when one is operative, the other may be inoperative. Further, if the liquid level 115 in one vessel 202 (e.g., the first one) becomes too low, liquid from the second vessel 202 could be pumped into the first one to maintain the fluid level 115 at a desired operational height (even if it means the fluid level 115 in the second vessel 202 will render it inoperative).

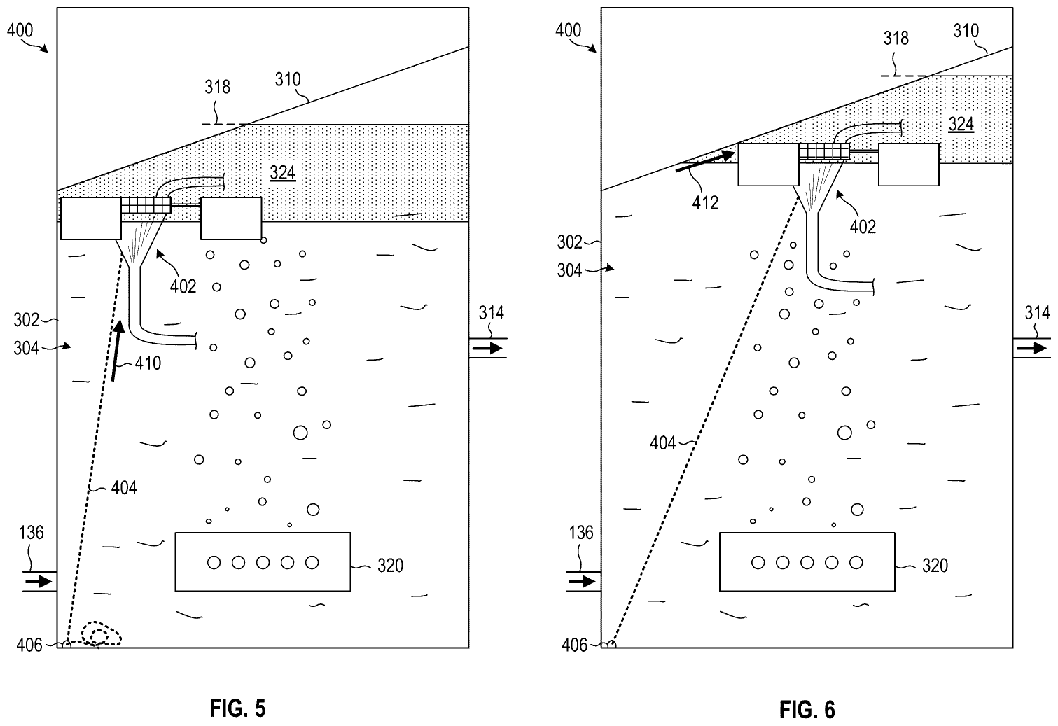

FIGS. 5-6 illustrate a fourth embodiment of a FOG separation apparatus 400; in these FIGS, only the second reservoir 302 is illustrated with the first reservoir 102 being, for example, as illustrated in FIG. 4. A primary development in the apparatus 400 is that the second vessel 302 no longer has the weir outlet 316 (as in FIG. 4) but rather has a second floating weir 402.

The second floating weir 402 is configured similarly, or identically, to the first floating weir 120 of FIGS. 1-3; however, it is not intended to harvest or collect FOG but rather the slurry 324 formed as a result of the action of the bubbler 320. Accordingly, the floating weir 402 itself may have minor adaptations, e.g., due to a different consistency of the slurry 324 compared to the FOG 108.

Notably, in this embodiment, the FOG separation apparatus 400 comprises a tether or guide means 404 connected to the second floating weir 402. In this example, the tether 404 may be in the form of a weighted chain connected to an anchor point 406 in a floor of the second vessel 302. The tether 404 is heavy enough to pull and urge the floating weir to one side (the left side, in FIGS. 5-6) but not heavy enough to overcome the buoyancy of the floating weir 402. This causes the floating weir 402 to be urged against the inclined wall 310 or the left wall of the vessel 302 regardless of its level.

This is further illustrated as the difference between FIG. 5 and FIG. 6. As the liquid level 318 rises, the floating weir 402 rises too, as indicated by arrow 410 (FIG. 5), and pulls up the tether 404. Correspondingly, as the floating weir 402 continues to rise, the inclined wall 310 urges it laterally (right, in the example) towards an apex thereof as illustrated by arrow 412 (FIG. 6). Lowering the liquid level 318 will have the reverse action, causing the floating weir 402 to fall with the falling liquid level 318 while “hugging” the inclined wall 310 due to the urging action of the tether 404. This permits control of both a height and lateral position of the floating weir 402 for collection of the slurry 324. (Instead, or in addition, the apparatus 100 of FIG. 1 may include a tether connected to the weir 120.)

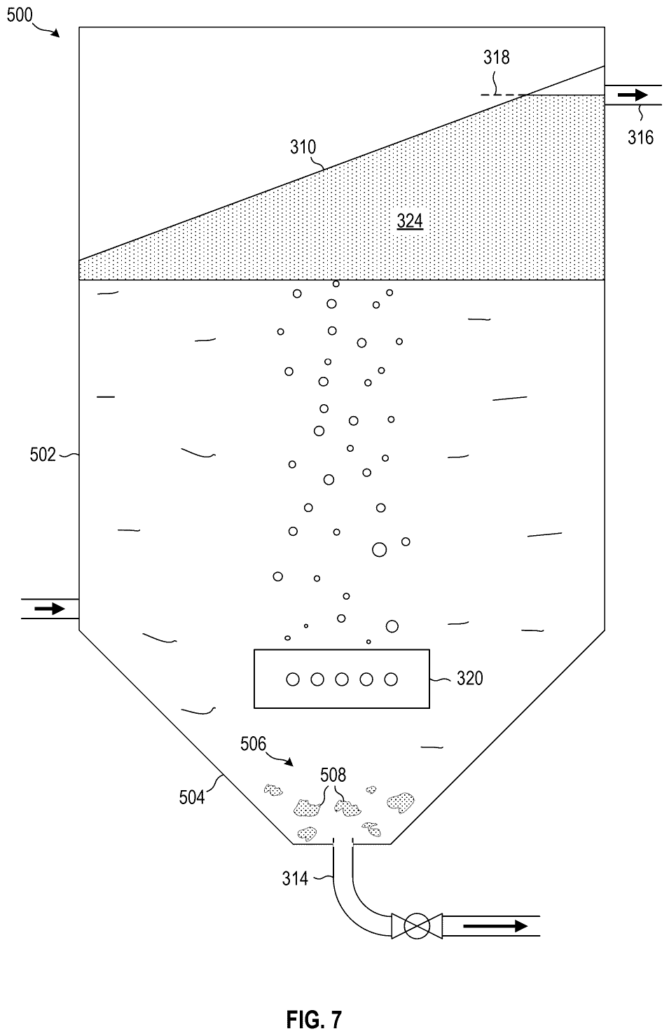

FIG. 7 illustrates another variant of a second vessel 502 which is essentially a combination of the features of the second vessel 302 of FIG. 4 and the tapered sump 206 of FIG. 3. More specifically, the second vessel 502 has inclined sides 504 at its bottom to provide a tapered sump 506. Denser or sinking solids 508 will collect and settle in the tapered sump 506 and the second main outlet 314 is now provided at a bottom of the tapered sump 506 to release, suck, or syphon out the settled solids 508. Accordingly, the second vessel 502 in this example is configured to remove solids at various levels: floating or settled solids 508 from the tapered sump 506 and suspended or floating solids via the weir outlet 316 or second floating weir 402, depending on the configuration.

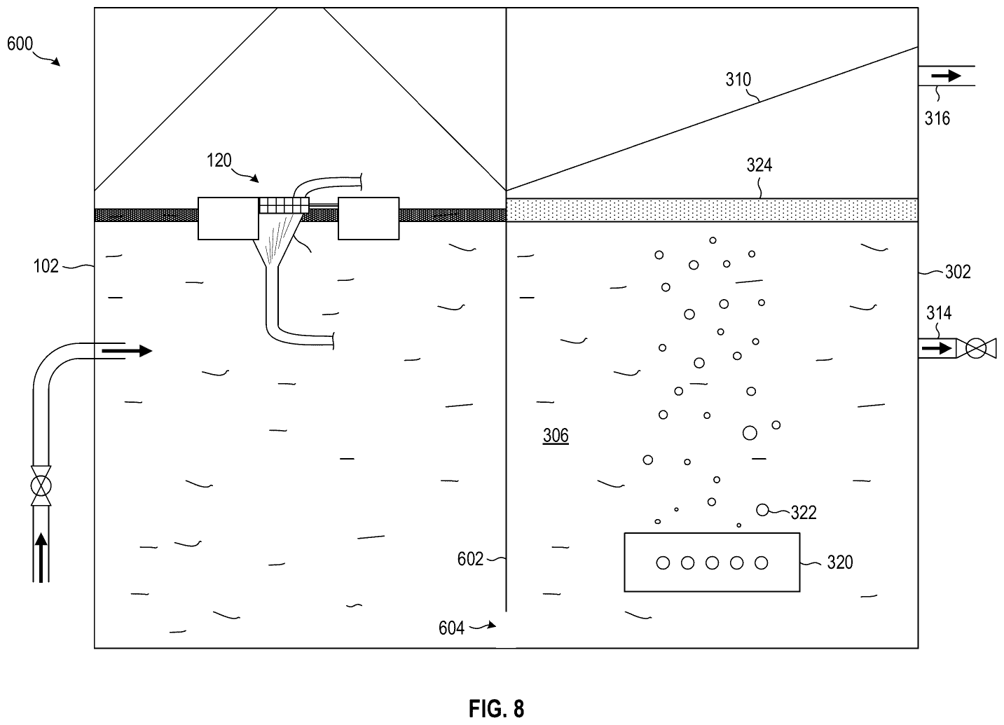

FIG. 8 illustrates a different embodiment of a FOG separation apparatus 600 which is very similar to the apparatus 300 of FIG. 4; instead of the first and second vessels 102, 302 being connected by the main outlet 136, they are separated by a baffle 602 defining an underflow zone 604. Accordingly, the first and second vessels 102, 302 may be defined by, or housed in, the same physical structure or enclosure; for the purposes of this specification, they are still considered to be separate vessels (or reservoirs).

The Applicant believes that the invention as exemplified has a number of advantages:
The concentration of the FOG 108 in the first vessel 102 can be controlled indirectly by controlling the liquid level 114. The funnelling action of the inclined walls 110 serves to concentrate or distribute a concentration (wherein “concentration” in this context is defined as being thicker/higher but smaller laterally).
The floating weir 120 ensures optimum height positioning within the inclined/tapered walls 110.
The liquid level 114 can be raised in two ways: providing influent 134 or other liquid via the main inlet 130 or provided flushing or recirculated water via the weir inlet 126.
The liquid level 114 can be lowered in two ways: outputting wastewater 106 via the main outlet 136 or removing FOG 108 via the weir outlet 128.
In some additional embodiment, effective configurations are disclosed for removing solids (whether sinking, suspended, or floating).

What is claimed is:

1. A FOG (Fats, Oils, or Grease) separation apparatus which includes:
a vessel or reservoir defining therein a cavity to contain liquid comprising wastewater and FOG, the vessel having an upwardly inwardly inclined side or top wall so that the cavity tapers inwardly towards a top section thereof;
a floating weir operable to float at a surface of the liquid within the vessel, the floating weir being configured to collect or separate lighter FOG from heavier wastewater; and
a liquid level control mechanism configured to control a liquid level of the liquid within the vessel, such that:
when the liquid level is higher within the top section, a surface area of the liquid will be smaller due to the inwardly tapering cavity and the FOG will be concentrated in the smaller surface area; and
when the liquid level is lower within the top section or is beneath the top section, the surface area of the liquid will be larger, and the FOG will be distributed in the larger surface area.

2. The FOG separation apparatus as claimed in claim 1, wherein varying the liquid level within the reservoir varies the depth and/or concentration of FOG at the surface.

3. The FOG separation apparatus as claimed in claim 1, including one or more fluid inlets or outlets, namely at least of:
a main inlet (for liquid);
a main outlet (for wastewater);
a weir inlet (for flushing or recirculated liquid); and/or
a weir outlet (for FOG collected by the floating weir).

4. The FOG separation apparatus as claimed in claim 3, in which the liquid level control mechanism is configured to control the liquid level by controlling the net inflow or outflow of liquid through the fluid inlets or outlets.

5. The FOG separation apparatus as claimed in claim 4, in which:
at least one of the fluid inlets or outlets have valves or taps associated therewith; and
the liquid level control mechanism is configured to control the liquid level by controlling the valves or taps.

6. The FOG separation apparatus as claimed in claim 4, in which the liquid level control mechanism is embodied by an electronic control module configured to control the liquid level automatically or programmatically.

7. The FOG separation apparatus as claimed in claim 6, which includes at least one sensor communicatively coupled to the electronic control module, the electronic control module being configured to control the liquid level in accordance with signals received from the sensor and one or more predefined operational parameters.

8. The FOG separation apparatus as claimed in claim 1, in which:
a bottom of the vessel include a tapered sump; and
a drain outlet is provided at a low point of the sump to drain to collect dense or sinking material.

9. The FOG separation apparatus as claimed in claim 1, which includes a bubbler provided in the cavity to supply bubbles or nanobubbles to the liquid.

10. The FOG separation apparatus as claimed in claim 1, in which the vessel is a first vessel and the FOG separation apparatus includes a second vessel provided in-line with and downstream of the first vessel.

11. The FOG separation apparatus as claimed in claim 10, in which the second vessel defines therein a second cavity to contain liquid comprising wastewater and has an upwardly inwardly inclined side or top wall so that the cavity tapers inwardly towards a top section thereof.

12. The FOG separation apparatus as claimed in claim 11, in which the second vessel includes a second floating weir operable to float at a surface of the liquid within the second vessel.

13. The FOG separation apparatus as claimed in claim 12, which includes a bubbler provided in the second cavity of the second vessel to supply bubbles or nanobubbles to provide liquid agitation and/or act as a flocculant to bind to suspended particles.

14. The FOG separation apparatus as claimed in claim 13, in which the bubbles cause a foam or slurry to form which is buoyant relative to the remainder of the wastewater, and wherein the second floating weir is configured to collect or harvest this foam or slurry.

15. The FOG separation apparatus as claimed in claim 13, the bubbles influence an oxygen level of the liquid and influence Chemical Oxygen Demand (COD) based reactions which occur in the second vessel.

16. The FOG separation apparatus as claimed in claim 12, in which the second floating weir is tethered to the second vessel by a tether configured to draw or urge the second floating weir back to a reference point.

17. The FOG separation apparatus as claimed in claim 10, in which a bottom of the second vessel includes a tapered sump with a drain outlet is provided at a low point of the sump to drain or collect dense or sinking material.

18. A method of operating a FOG separation apparatus as claimed in claim 1, the method including:
varying the liquid level within the top section to vary the surface area of the liquid, and hence of the FOG at the top of the liquid; and
collecting the FOG with the floating weir.
